(19) United States
(12) Patent Application Publication
(10) Pub. No.: US 2025/0209099 A1
(43) Pub. Date: Jun. 26, 2025

(54) PROMPT ADAPTATION FOR MACHINE-LEARNING LARGE LANGUAGE MODELS (LLMS)

(71) Applicant: Maplebear Inc., San Francisco, CA (US)

(72) Inventors: Jacob Jensen, Metuchen, NJ (US); Shubhanshu Mishra, Woodridge, IL (US); Sahil Khanna, San Jose, CA (US); Ryan Dearing, Boise, ID (US); David Vengerov, San Jose, CA (US); Aomin Wu, Scarsdale, NY (US); Shishir Kumar Prasad, San Ramon, CA (US); Haixun Wang, Bellevue, WA (US)

(21) Appl. No.: 19/000,108

(22) Filed: Dec. 23, 2024

Related U.S. Application Data
(60) Provisional application No. 63/614,910, filed on Dec. 26, 2023.
(60) Provisional application No. 63/626,988, filed on Jan. 30, 2024.

(51) Int. Cl. G06F 16/334; G06F 16/332

(52) U.S. Cl. CPC G06F 16/334; G06F 16/332

(57) ABSTRACT

The online system is configured to efficiently handle user requests by choosing a suitable prompt from a pre-curated library and selecting one of a plurality of large language models (LLMs) to respond to the user queries. These prompts are tailored for compatibility with different LLMs. When a user query is received, the system simultaneously forwards it to multiple LLMs and receives diverse responses. Performance metrics are then generated based on these multiple responses, aiding in the selection of the most suitable LLM. The chosen LLM is used for processing subsequent queries from the same user. This approach not only ensures that users receive high-quality, prompt responses but also optimizes the system's performance by dynamically selecting the most efficient LLM based on both quality and speed.

### CROSS-REFERENCE TO RELATED APPLICATIONS

This application claims the benefit of U.S. Provisional Patent Application No. 63/614,910, filed on Dec. 26, 2023, and U.S. Provisional Patent Application No. 63/626,988, filed on Jan. 30, 2024, all of which are incorporated by reference herein in their entirety.

### BACKGROUND

An online system may receive client requests (e.g., LLM-based chatbot requests) that are processed in conjunction with large-scale models such as large language models (LLMs). The online system may have access to multiple deployments or LLM services at a given time. The performance of large language models (LLMs) can vary for several reasons, and these differences may manifest at different times or under different conditions. First, different LLMs may have been trained using distinct algorithms, data sets, and optimization techniques, which can lead to variations in both their speed and accuracy on different tasks. Both the training and inference stages introduce certain elements of randomness into LLMs. This stochastic nature can result in slight variations in performance even when the same query is made multiple times. Further, the manner in which a question or task (e.g., prompt) is presented to an LLM can significantly affect its ability to generate a relevant and accurate response. This encompasses the vocabulary used, the structure of the sentence, and the clarity of the intent behind the query. For the same task, different LLMs may do better or worse depending on the structure and content of the prompt describing the request. Moreover, ambiguous or vague questions can confuse the LLM, leading to answers that may not meet the user's actual requirements. Questions that are too general might result in broad or imprecise answers. Providing additional context can help the LLM in understanding the nuance or specialized requirements of a question.

Additionally, the performance may also vary depending on the current load on the servers hosting the LLM. The server load refers to the amount of computational work that the server is currently handling. This can include not only the requests being made to the LLM but also other operations that the server might be performing simultaneously. The server load can influence the response time and sometimes even the quality of the output generated by the LLM. Therefore, it is a technically difficult problem to determine how different large-scale model deployments can be used to provide optimal user experience.

### SUMMARY

In accordance with one or more aspects of the disclosure, the techniques described herein relate to a method and system for selecting one or more LLM services. Specifically, an online system receives, from a client device, a query from a user for an application of an online system with access to one or more of a set of LLM services. The online system obtains contextual information as a set of features, the set of features related to the query or the user of the client device. The online system applies at least one machine-learning contextual bandit model to the set of features to generate a set of predicted scores, wherein each predicted score in the set of predicted scores indicates how effective a response from a respective LLM service in the set of LLM services is with respect to a desired outcome. The online system selects an LLM service in the set of LLM services based at least on the set of predicted scores from the contextual bandit model. The online system generates a prompt for input to the selected LLM service, wherein the prompt for the selected LLM service is generated based on a prompt template in a prompt library database associated with the selected LLM service. The online system receives, from the selected LLM service, a response generated by executing the selected LLM service on the prompt. The online system prompts the selected LLM service to process subsequent queries from the same user.

In accordance with one or more aspects of the disclosure, the techniques described herein relate to a method and system for evaluating conversations between different chatbot applications. Specifically, an online system obtains one or more transcripts generated by a chatbot application, a transcript including a conversation between a user and the chatbot application. The online system obtains post conversation user engagement data, the post conversation user engagement data for a transcript indicating how a user interacted with the online system responsive to having the conversation with the chatbot application in the transcript. The online system generates a prompt for a machine learning model, wherein the prompt includes a request to evaluate the conversation in the transcript based on a set of given criteria, the prompt including at least contents of the conversation and the post conversation user engagement data. The online system receives as output from the machine learning model a set of scores evaluating the conversation based on the set of given criteria.

In some aspects, the techniques described herein relate to a method and system. An online system obtains a plurality of conversations for a first chatbot application and another plurality of conversations for a second chatbot application. The online system evaluates each of the conversations in the user interaction data. The online system maps each of the plurality of conversations and the another plurality of conversations to a respective embedding by providing a prompt to a machine learning model. The online system matches conversations from the first chatbot application to similar conversations from the second chatbot application to generate one or more pairs of matching conversations, and wherein matching conversations is based on a user issue of the matched conversations. For each matched pair of conversations, the online system generates one or more evaluations that compare the first chatbot application to the second chatbot application on handling the user issue based on the comparison of the matched conversations.

In some aspects, the techniques described herein relate to a method and system. An online system receives a transcript of a chatbot application with a user, the conversation including at least a sequence of messages from the user and a respective response to each user message from the chatbot application. For each of the sequence of user messages, the online system simulates responses using a second chatbot application different from the first chatbot application. The online system further simulates a response to the user message by providing the user message to the second chatbot application, for each response, evaluating the response from the second chatbot application as compared to the corresponding response from the first chatbot application in the original transcript, identifying a prior context similarity between previous simulated responses and corresponding responses in the original transcript, and identifying a confidence score for the evaluation of the second chatbot application based on the prior context similarity, wherein the confidence score is higher when the prior context similarity is higher.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 illustrates an example architecture of an LLM gateway module, in accordance with one or more embodiments.

FIG. 4 is a flowchart for a method of prompt adaptation between multiple LLMs, in accordance with one or more embodiments.

FIG. 5 is a flowchart for a method of evaluating chatbots using post conversation user engagement data, in accordance with some embodiments.

FIG. 6 is a flowchart for a method of matching chatbot conversations for comparison, in accordance with some embodiments.

### DETAILED DESCRIPTION

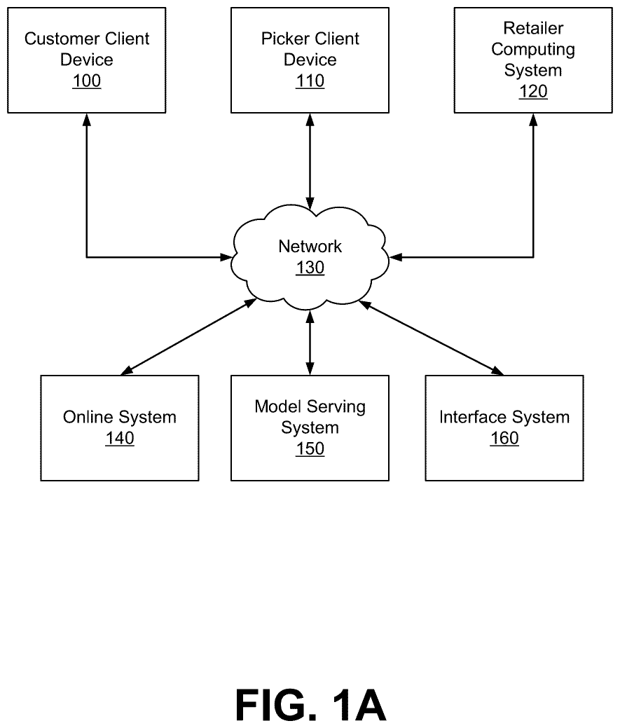

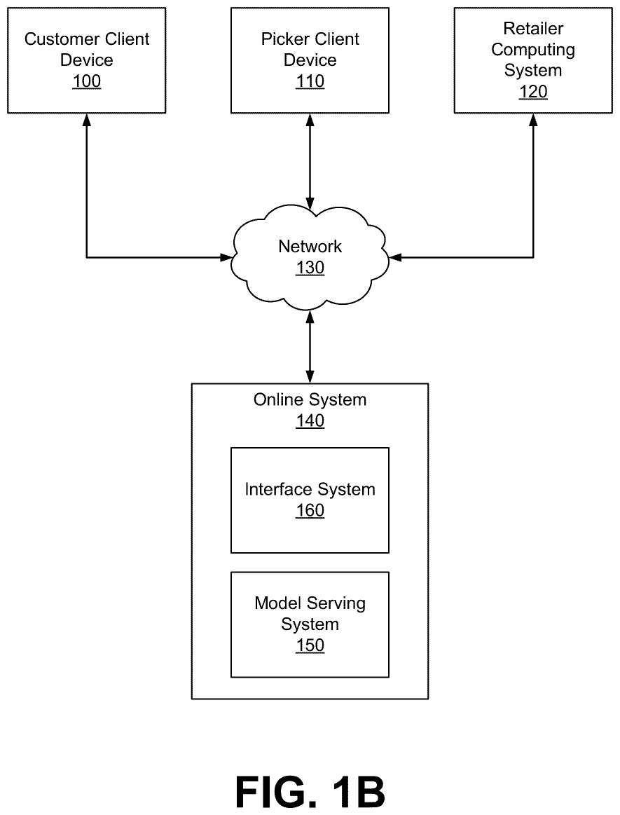

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

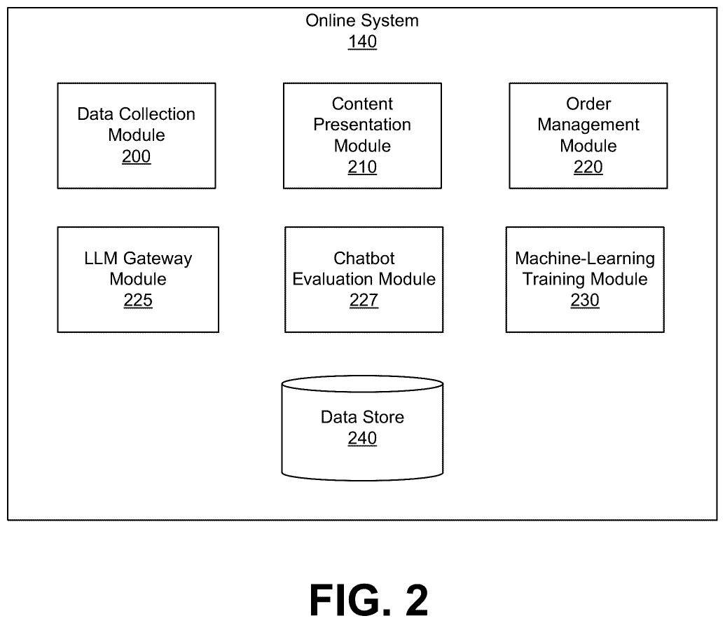

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform inference tasks using machine-learning models. The inference tasks include, but are not limited to, natural language processing (NLP) tasks, audio processing tasks, image processing tasks, video processing tasks, and the like. In one or more embodiments, the machine-learning models deployed by the model serving system 150 are models configured to perform one or more NLP tasks. The NLP tasks include, but are not limited to, text generation, query processing, machine translation, chatbot applications, and the like. In one or more embodiments, the language model is configured as a transformer neural network architecture. Specifically, the transformer model is coupled to receive sequential data tokenized into a sequence of input tokens and generates a sequence of output tokens depending on the inference task to be performed.

The model serving system 150 receives a request including input data (e.g., text data, audio data, image data, or video data) and encodes the input data into a set of input tokens. The model serving system 150 applies the machine-learning model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one or more instances, the LLM may be trained and hosted on a cloud infrastructure service. The LLM may be trained by the online system 140 or entities/systems different from the online system 140. An LLM may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

In one or more embodiments, when the machine-learning model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a task request and additional contextual information that is useful for responding to the query. The LLM infers the response to the query from the knowledge that the LLM was trained on and/or from the contextual information included in the prompt.

In one or more embodiments, the inference task for the model serving system 150 can primarily be based on reasoning and summarization of knowledge specific to the online system 140, rather than relying on general knowledge encoded in the weights of the machine-learning model of the model serving system 150. Thus, one type of inference task may be to perform various types of queries on large amounts of data in an external corpus in conjunction with the machine-learning model of the model serving system 150. For example, the inference task may be to perform question-answering, text summarization, text generation, and the like based on information contained in the external corpus.

Thus, in one or more embodiments, the online system 140 is connected to an interface system 160. The interface system 160 receives an external corpus of data from the online system 140 and builds a structured index over the data using another machine-learning language model or heuristics. The interface system 160 receives one or more task requests from the online system 140 based on the external data. The interface system 160 constructs one or more prompts for input to the model serving system 150. A prompt may include the task request of the user and context obtained from the structured index of the external data. In one or more instances, the context in the prompt includes portions of the structured indices as contextual information for the query. The interface system 160 obtains one or more responses to the query from the model serving system 150 and synthesizes a response. While the online system 140 can generate a prompt using the external data as context, oftentimes, the amount of information in the external data exceeds prompt size limitations configured by the machine-learning language model. The interface system 160 can resolve prompt size limitations by generating a structured index of the data and offers data connectors to external data and provides a flexible connector to the external corpus.

In some embodiments, the effectiveness of various language models (LLMs) utilized by the online concierge system 140 may not be immediately apparent. To address this, user information can be input into the interface system 160, which then maps this information to the most suitable LLM. This is facilitated by the system's capability to create a structured index from the external data corpus, enhancing the selection process of appropriate LLMs for specific user requests.

In one or more embodiments, the online system 140 described herein is configured to send user requests to multiple deployments of large-scale models (e.g., different LLMs). Different LLMs perform differently on the same task depending on, for example, with different prompts. In one or more embodiments, the online system 140 described herein evaluate different LLM services and also chooses a prompt for each different LLM service (which may include LLMs hosted by third-party and self-hosted LLMs). The online system 140 includes a gateway service capable of dispatching a query to multiple LLM services.

In one or more embodiments, the online system 140 has access to a prompt library that is populated with quality prompts and/or prompt templates for each LLM service. In one or more instances, these quality prompts and/or prompt templates for each LLM may be obtained by offline testing. Different types of modality may be included in the prompts or prompt templates, such as text, image, sound, video, etc.

Responsive to receiving a request from a client device of a user, the online system 140 described herein dynamically chooses between different deployments or hosted large-scale machine-learning models. In one or more instances, the models are LLMs, but it is appreciated that any other large-scale model can be applied. In particular, one model hosted by a particular service might be unreliable (e.g., server failure) at some time, and/or different models are tuned based on different prompts and/or intents. Therefore, the online system 140 described herein generates one or more policies that determine how client queries are routed to different model deployment services.

A first policy is a set of heuristics or rules where the online system 140 designates a preferred LLM deployment service (e.g., LLM deployed by Service A), a first backup LLM deployment (e.g., LLM deployed by Service B), and a second backup LLM deployment, and so on. Each deployment is paired with a unique prompt template.

A second policy is to query multiple LLMs in parallel and select a model for the request based on one or more performance metrics. Specifically, instead of waiting for one model to fail or having a circuit breaker, the models are queries in parallel and depending on the performance metrics (e.g., latency) important for the query, the online system 140 selects the model responsible for the preferred response. For example, latency is an important factor for chatbot applications. The online system 140 generates a model-specific prompt for each LLM, and provides the model-specific prompts to multiple LLMs. Each of the multiple LLMs receives the respective prompts and generates a response based on the received prompts. The online system 140 receives the responses from the multiple LLMs and determines performance metrics of the set of LLMs based in part on the responses.

In some embodiments, the performance metrics of each LLM include at least one of quality of the response generated by a corresponding LLM, a latency of the corresponding LLM for generating the response, and/or a cost of the corresponding LLM for generating the response. In some embodiments, an overall performance score is determined based on the performance metrics, and the selection of the LLM from the plurality of LLMs is based on the overall performance score. For example, the online system 140 may select the LLM deployed by a service with the highest overall performance score. The selected LLM service may handle generating responses for subsequent queries from the same user or client device.

A third policy is to incorporate a contextual bandit experimentation to select or guide selection of the LLM deployment. In some embodiments, the online system 140 considers contextual information associated with the user or the user request in selecting the LLM. This may be achieved by applying one or more pretrained machine-learning contextual bandit models to the contextual information associated with the user or the user to generate predicted scores with respect to one or more desired outcomes.

In one or more instances, the contextual information includes at least one or a combination user information in the form of feature vectors or the content of the user query as, for example, mapped to an embedding in a latent space. A given contextual bandit model outputs scores between different LLM deployments that indicate how likely the responses from the respective LLM service are effective for the query with respect to a desired outcome by the online system 140. For example, a score for a respective LLM service may indicate a degree of favorable user behavior like adding an item to a user's cart in response to being presented with a marketing message response related to the item when the user is interacting with a chatbot application powered by the LLM. Given contextual information including content of a user query (e.g., “What are good ingredients for making chicken masala?”) and user information for the user of the query, a contextual bandit model may output a respective score for each available LLM service indicating whether a response from the respective service will result in the desired outcome of the user adding an item to the user's order.

In one or more embodiments, the online system 140 may also combine the scores (e.g., generated from contextual bandit models) or values of the performance metrics to select a LLM service for addressing the user's queries. This policy allows the online system 140 to customize the choice of LLM service to each individual user and the contextual information for that user or the query depending on which aspects are important to that query.

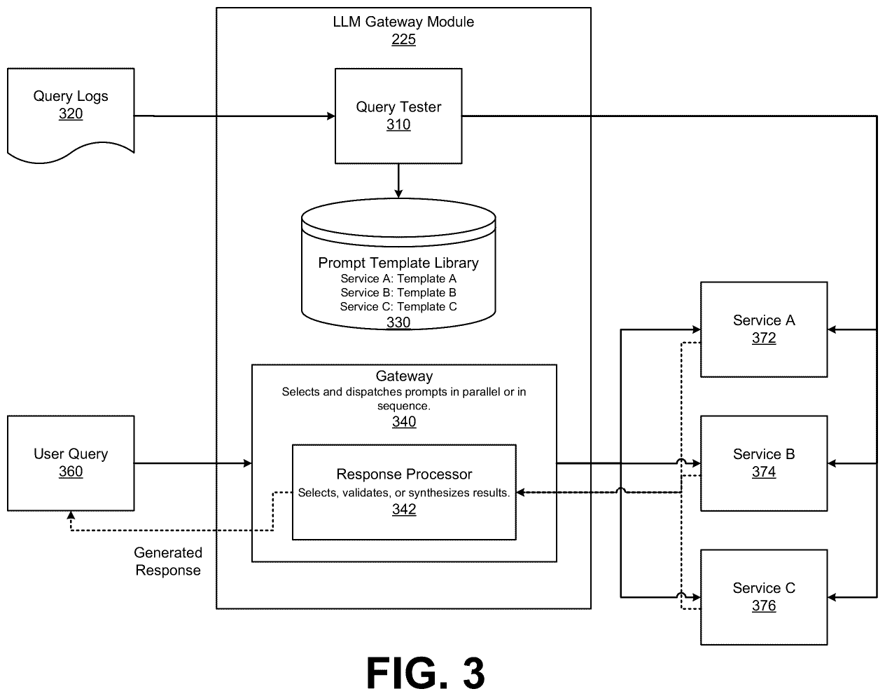

As such, the online system 140 described herein can dynamically select an LLM that suits the context of the user and the query and the states of the LLMs. The online system 140 can also continuously learn and adapt its selection of the LLMs based on incoming data, refining its scoring over time for better outcomes. It also allows for the accurate estimation of the effectiveness of different methods, improving the quality of decisions and, ultimately the user experience. A more detailed description of this method and system is further provided below in conjunction with FIG. 3.

In one or more embodiments, the online system 140 described herein also provides a method for evaluating conversations between different chatbot applications that may be powered by a set of LLM services. Specifically, chatbot applications may be assessed based on the quality of the conversations that are held with users. Specific guidelines may be used to rate these conversations against certain criteria essential for a good user experience. As chatbot applications progress, assessing the enhancements between versions becomes vital. However, an inherent challenge is the variability of conversations, even on similar topics, which complicates direct comparisons. Thus, the online system 140 described herein provides a way to evaluate conversations that are generated by a set of chatbot applications powered by a set of LLM services, so that even if there is variability, the performance between chatbot applications can be effectively evaluated.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 are each managed by an entity separate from the entity managing the online system 140. In one or more embodiments, as illustrated in the example system environment in FIG. 1B, the model serving system 150 or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a LLM gateway module 225, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

In one or more embodiments, the data collection module 200 also collects communication data, which is different types of communication between shoppers and users of the online system 140. For example, the data collection module 200 may obtain text-based, audio-call, video-call based communications between different shoppers and users of the online system 140 as orders are submitted and fulfilled. The data collection module 200 may store the communication information by individual user, individual shopper, per geographical region, per subset of users having similar attributes, and the like.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine-learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine-learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

In one or more embodiments, the content presentation module 210 receives one or more recommendations for presentation to the customer while the customer is engaged with the ordering interface. The list of ordered items of a customer may be referred to as a basket. As described in conjunction with FIGS. 1A and 1B, the recommendations are generated based on the inferred purpose of the basket of the customer and include one or more suggestions to the customer to better fulfill the purpose of the basket.

In one or more instances, the recommendations are in the form of one or more equivalent baskets that are modifications to an existing basket that serve the same or similar purpose as the original basket. The equivalent basket is adjusted with respect to metrics such as cost, healthiness, whether the basket is sponsored, and the like. For example, an equivalent basket may be a healthier option compared to the existing basket, a less expensive option compared to the existing basket, and the like. The content presentation module 210 may present the equivalent basket to the customer via the ordering interface with an indicator that states how an equivalent basket improves or is different from the existing basket (e.g., more cost-effective, healthier, sponsored by a certain organization). The content presentation module 210 may allow the customer to swap the existing basket with an equivalent basket.

In one or more instances, when the basket includes a list of edible ingredients, the recommendations are in the form of a list of potential recipes the ingredients can fulfill, and a list of additional ingredients to fulfill each recipe. The content presentation module 210 may present each suggested recipe and the list of additional ingredients for fulfilling the recipe to the customer. The content presentation module 210 may allow the customer to automatically place one or more additional ingredients in the basket of the customer.

The order management module 220 that manages orders for items from customers. The order management module 220 receives orders from a customer client device 100 and offers the orders to pickers for service based on picker data. For example, the order management module 220 offers an order to a picker based on the picker's location and the location of the retailer from which the ordered items are to be collected. The order management module 220 may also offer an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to offer an order to a picker based on a delivery timeframe requested by the customer with the order. The order management module 220 computes an estimated amount of time that it would take for a picker to collect the items for an order and deliver the ordered item to the delivery location for the order. The order management module 220 offers the order to a picker at a time such that, if the picker immediately services the order, the picker is likely to deliver the order at a time within the timeframe. Thus, when the order management module 220 receives an order, the order management module 220 may delay in offering the order to a picker if the timeframe is far enough in the future.

When the order management module 220 offers an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine-learning training module 230 trains machine-learning models used by the online system 140. For example, the machine-learning module 230 may train the item selection model, the availability model, or any of the machine-learned models deployed by the model serving system 150. The online system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers.

Each machine-learning model includes a set of parameters. A set of parameters for a machine learning model are parameters that the machine-learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning-training module 230 generates the set of parameters for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include customer data, picker data, item data, or order data. In some cases, the training examples also include a label which represents an expected output of the machine learning model. In these cases, the machine-learning model is trained by comparing its output from input data of a training example to the label for the training example.

The machine-learning training module 230 may apply an iterative process to train a machine learning model whereby the machine-learning training module 230 trains the machine learning model on each of the set of training examples. To train a machine-learning model based on a training example, the machine learning training module 230 applies the machine-learning model to the input data in the training example to generate an output. The machine-learning training module 230 scores the output from the machine learning model using a loss function. A loss function is a function that generates a score for the output of the machine learning model such that the score is higher when the machine learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learning models hosted by the model serving system 150, the machine-learning models may already be trained by a separate entity from the entity responsible for the online system 140. In another embodiment, when the model serving system 150 is included in the online system 140, the machine-learning training module 230 may further train parameters of the machine-learning model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

### 1. Gateway and Prompt Adaption for LLM Services

The LLM gateway module 225 is a gateway service configured to select an LLM among multiple LLM services based on a user query and performance metrics obtained from the multiple LLM services. Notably, different LLMs perform differently on the same task with different prompts. The LLM gateway module 225 described herein chooses a better prompt for each different LLM service (which may include self-hosted LLMs by the online system 140 or LLMs hosted by other entities). The LLM gateway module 225 includes a gateway service capable of dispatching a query to multiple LLM services.

In one or more embodiments, the LLM gateway module 225 has access to a prompt template library that includes multiple prompt templates, each of which is populated with quality prompts for a corresponding LLM hosted by a respective service. The quality prompts for each LLM may be obtained by offline testing. Different types of modality may be included in the prompts or prompt templates, such as text, image, sound, video, and the like.

The LLM gateway module 225 described herein generates one or more policies that determine how client requests are routed to different model deployment services. Specifically, responsive to receiving a query from a client device of a user, the LLM gateway module 225 generates a model-specific prompt for each LLM, and provides the model-specific prompts to multiple LLMs. The model-specific prompt for a given LLM is generated based on the prompt template for the LLM in the prompt library.

A first policy may include a set of heuristics or rules where the LLM gateway module 225 designates a preferred service or LLM deployment (e.g., LLM deployed by Service A), a first backup LLM deployment (e.g., LLM deployed by Service B), and a second backup LLM deployment (e.g., LLM deployed by Service C), and so on. Each deployment may be paired with a unique prompt template.

A second policy may include querying a set of LLM services in parallel, and selecting a model for the request based on one or more performance metrics. Each of the set of LLMs receives the respective prompts and generates a response based on the received prompt. The LLM gateway module 225 receives the responses from the set of LLMs and determines performance metrics of the set of LLMs based on the responses. The performance metrics may include, but are not limited to, quality of the response generated by a corresponding LLM (e.g., high quality vs. low quality), a latency of the corresponding LLM for generating the response (e.g., in units of milliseconds), or a cost of the corresponding LLM (e.g., in units of CPU usage or dollar amount) for generating the response.

In one or more instances, one or more of the performance metrics may be obtained in the process of receiving the response, e.g., as a respective LLM service is providing the response at response time. In one or more instances, some of the performance metrics may be obtained offline, e.g., quality of response. The values for performance metrics such as cost can also be generated relatively deterministically by computing the cost to process a number of input tokens that are in the prompt. The different responses received from the set of LLMs may be stored and compared offline for additional prompt evaluation. In some embodiments, experiments may be run automatically to compare performance of different prompts or different LLM services.

In some embodiments, online system 140 may compute an overall performance score based on one or more performance metrics. As an example, the online system 140 may determine a performance score for LLM offered by Service B over Service A based on the following Equation (1):

$$p ( quality\_B > quality\_A ) * p ( latency\_B < latency\_A ) * E ( cost\_A ) / E ( cost\_B ) \qquad ( 1 )$$

In the above Equation (1), p(⋅) denotes a probability, and E(⋅) denotes an expected value. As such, p(quality_B>quality_A) represents a probability that the quality of Service B is greater than the quality of Service A, p(latency_B<latency_A) represents a probability that the latency of Service B is lower than the latency of Service A, E(cost_A) represents expected costs associated with Service A, E(cost_B) represents expected costs associated with Service B. As such, the above Equation (1) computes an overall performance score indicating relative performance between Service A and Service B based on each of Service A and Service B's response qualities, latencies, and/or costs. The service with a higher performance score may be selected for the request. Moreover, different performance metrics may be weighted differently, thus, when latency is an important factor, the latency term in Equation (1) may be weighted higher than the terms for cost and quality.

It is appreciated that equation (1) is merely an example method for computing an overall performance score. Other methods may also be implemented to compute overall performance scores. Similarly, an overall score may be computed for three or more services, indicating relative performance among the three or more services.

A third policy may include using contextual bandit experimentation. In some embodiments, contextual information associated with the user or user query may also be considered in selecting the LLM service. In one or more instances, the contextual information includes at least one or a combination user information in the form of feature vectors or content of the user query as, for example, an embedding in a latent space. A given contextual bandit model outputs scores between different LLM deployments that indicate how likely the responses from the respective LLM service are effective with respect to a desired outcome by the user.

The LLM gateway module 225 applies contextual bandits to provide a framework for real-time experimentation, enabling machine-learning contextual bandit models to make decisions based on contextual features. In one or more instances, these decisions aim to optimize or increase specific desired outcomes, like user engagement, sales, conversion rates, by dynamically selecting among various methods of response. The different selections may correspond to different prompts or prompt templates, or LLM services.

In some embodiments, the machine-learning bandit model is a classifier model. The machine-learning bandit model may be trained to use features from the contextual information to score various possible responses from the set of LLM services. The features may be variables that characterize the current situation, such as user characteristics and initial queries in a chatbot scenario. The scores a contextual bandit model may indicate the estimated effectiveness of the set of LLM services with respect to a desired outcome the contextual bandit model was trained for. The response will then actually be generated by a given LLM selection with probability proportional to the respective score for the LLM service. This approach avoids the waste of computational resources on less effective methods.

For example, a chatbot application may interact with two users: a first user shopping in a thrifty mode asking for staples and a second user in a luxury mode asking for prepared meals. When the users interact with the chatbot application, features like the mode (e.g., thrifty mode or luxury mode) and the initial query (“Where can I find affordable staples?” or “Show me the best-prepared meals”) are extracted. The machine-learning classifier assigns scores to different prompts and services (e.g., each service/prompt pair is a band) based on these features for a given user. For example, the classifier model might score “Option A: LLM from Service A” higher for the thrifty mode and “Option B: LLM from Service B” higher for the luxury mode. The chatbot application will then route the user queries from the user to the selected model with a higher propensity likelihood to generate one or more responses.

In one or more embodiments, a contextual bandit model is trained to output scores that indicate likelihoods of whether the responses from the set of LLM services will achieve a desired outcome. As an example, a contextual bandit model may be coupled to receive contextual information including an embedding of the user query or user information such as state of the user's order cart, demographic characteristics, sensitivity of the response at issue (e.g., response to critical customer support query or generating marketing text), and output a score for each respective LLM service that indicates a likelihood of the desired outcome. For example, when the response is for a critical customer support query, the output indicates a likelihood of successful customer care, considering factors such as low cost of remediation, whether the user continues to engage, and the like. As another example, when the response is for generating a marketing message (e.g., sponsored item), the output indicates a likelihood of the user adding the item to the user's cart.

In one or more embodiments, the LLM gateway module 225 may train other types of contextual bandit models that are coupled to receive contextual information and generate predicted scores for performance metrics like expected quality of the response, latency, cost, and the like. For example, a second contextual bandit model that are coupled to receive contextual information and generate predicted scores for the set of LLM services indicating likelihoods of receiving high-quality responses to the user query. As another example, a third contextual bandit model may be coupled to receive contextual information and generate predicted scores for the set of LLM services that indicate likelihoods of achieving a low latency response.

In one or more embodiments, the LLM gateway module 225 may combine any of the predicted scores from the contextual bandit models or the values obtained for one or more performance metrics into a multi-objective score to select a particular LLM service for addressing the queries. The multi-objective score may weigh the predicted scores or values obtained for the performance metrics depending on which component is important for providing an effective response for the online system 140. As an example, the LLM gateway module 225 may generate a quantity for Equation (1) after routing the initial user query to the set of LLM services, combine the quantity for Equation (1) with predicted scores for the LLM services from a contextual bandit model that indicates whether the user will perform the desired outcome of adding a sponsored item to the user's cart. As yet another example, when the latency is a significant factor user satisfaction, the weighted multi-objective score may weigh the prediction or value for latency by 0.8, while the prediction or value for response quality is weight by 0.1, and the prediction or value for cost is weight by 0.1 in the multi-objective score when selecting the LLM service for addressing queries from a user.

In one or more embodiments, parameters of a contextual bandit model may be trained by obtaining a training dataset including one or more training examples. A training example may be obtained from logs for a previously submitted query processed by one or more LLM services. The training example may include a training set of features obtained from the previously submitted query and a user of the query, and a known outcome for the previously submitted query. The known outcome may indicate whether a desired outcome was achieved (e.g., user was satisfied with the response or user converted on a sponsored item), or known values for one or more performance metrics for the LLM services. The LLM gateway module 225 trains the parameters of the contextual bandit model using the one or more training examples of the training dataset.

FIG. 3 is an example architecture of an LLM gateway module 225 in accordance with one or more embodiments. In one or more embodiments, the LLM gateway module 225 includes a query tester configured to receive query logs 320 of previous queries, and conduct offline or online tests to identify quality prompt templates for each LLM services. Therefore, the LLM gateway module 225 performs a feedback loop where queries processed by one LLM can be evaluated using another LLM and/or with counterfactuals. The identified quality prompt templates are then populated into a prompt template library 330. As illustrated, the prompt template library includes a set of prompt templates, one for each LLM service. In particular, a first template, template A, is configured to store quality prompt templates for LLM Service A 372, a second template, template B, is configured to store quality prompt templates for LLM Service B 374, and a third template, template C, is configured to store quality prompt templates for LLM Service C 376. The templates may be different from each other.

The LLM gateway module 225 also includes a gateway service 340 configured to receive user queries 360. When a user query 360 is received, the gateway service 340 selects prompt templates from the prompt library 330 for each service, and dispatches the prompts in parallel or in conditional sequence to the set of services 372, 374, 376. In some embodiments, the conditional sequence may implement a simple and few-parameter configuration that is compatible with circuit-breaker frameworks, which can be used to detect and handle failures or overloads.

The set of LLM services 372, 374, 376 each receive their respective prompt (e.g., synthesized from the respective prompt template for the service), and generates a response based on the received prompt, and sends the response back to the gateway service 340. The gateway service 340 includes a response processor 342 configured to select, validate, or synthesize the responses received from the services 372, 374, 376 and select one of the services to process further queries from the same client device or user. In some embodiments, the response processor 342 implements a simple and few-parameter configuration that is able to process responses in near real-time, leading to a quicker decision-making process.

In some embodiments, the response processor 342 determines performance metrics for each of the LLM services based on their responses. The performance metrics may include (but are not limited to) response time (i.e., latency), cost, quality of response, etc. In some embodiments, an overall performance score is computed based on multiple performance metrics. For example, the online system 140 may determine a call propensity score for LLM offered by Service B over Service A based on Equation (1) described above.

In some embodiments, the gateway service 340 accesses one or more contextual bandit models. For a given contextual bandit model, the gateway service 340 obtains the contextual features for the user query and generates predicted scores for each LLM service as described above. The gateway service 340 may incorporate the predicted scores from the contextual bandit models as well as the values for different performance metrics when selecting the LLM service for responding to subsequent queries from the user.

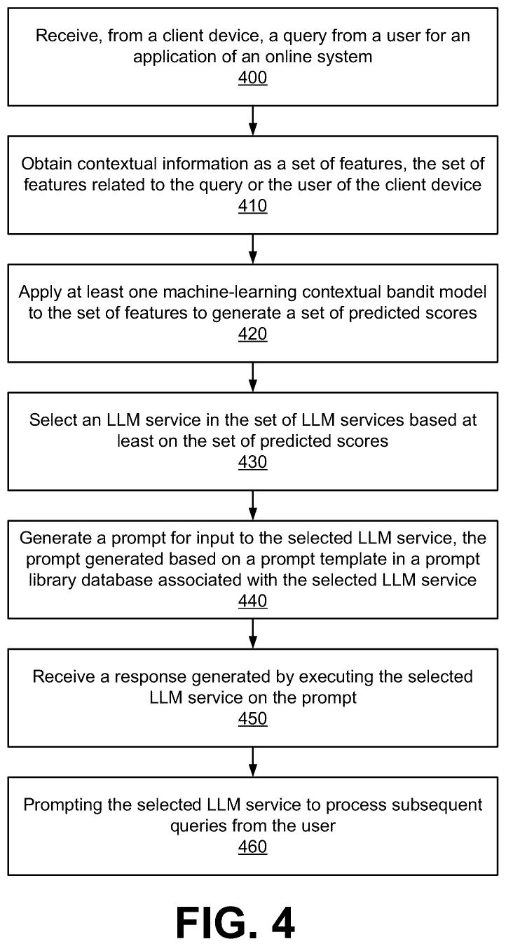

FIG. 4 is a flowchart for a method of prompt adaptation between a set of LLM services, in accordance with one or more embodiments. Alternative embodiments may include more, fewer, or different steps from those illustrated in FIG. 4, and the steps may be performed in a different order from that illustrated in FIG. 4. These steps may be performed by an online system (e.g., online system 140). Additionally, each of these steps may be performed automatically by the online system without human intervention.

The online system 140 receives 400, from a client device, a query from a user for an application of an online system with access to one or more of a set of LLM services. The online system 140 obtains 410 contextual information as a set of features, the set of features related to the query or the user of the client device. The online system 140 applies 420 at least one machine-learning contextual bandit model to the set of features to generate a set of predicted scores. In one or more embodiments, each predicted score in the set of predicted scores indicates how effective a response from a respective LLM service in a set of LLM services is with respect to a desired outcome. The online system 140 selects 430 an LLM service in the set of LLM services based at least on the set of predicted scores from the contextual bandit model. The online system 140 generates 440 a prompt for input to the selected LLM service. In one or more embodiments, the prompt is generated based on a prompt template in a prompt library database associated with the selected LLM service. The online system 140 receives 450, from the selected LLM service, a response generated by executing the selected LLM service on the prompt. The online system 140 prompts 460 the selected LLM service to process subsequent queries from the same user.

As such, the online system 140 described herein can dynamically select an LLM that suits the context of the user and the user request and the states of the LLMs. The online system 140 can also continuously learn and adapt its selection of the LLMs based on incoming data, refining its scoring over time for better outcomes. It also allows for the accurate estimation of the effectiveness of different methods, improving the quality of decisions and, ultimately the user experience.

### 2. Evaluation of LLM-Powered Chatbot Applications

In some embodiments, the chatbot evaluation module 227 obtains a plurality of conversations for a set of chatbot applications. For example, there may be a first chatbot application and a second plurality of conversations for a second chatbot application. The chatbot evaluation module 227 evaluates each of the conversations in the user interaction data. The chatbot evaluation module 227 maps each of the plurality of conversations and the second plurality of conversations to a respective embedding by providing a prompt to a machine-learning model.

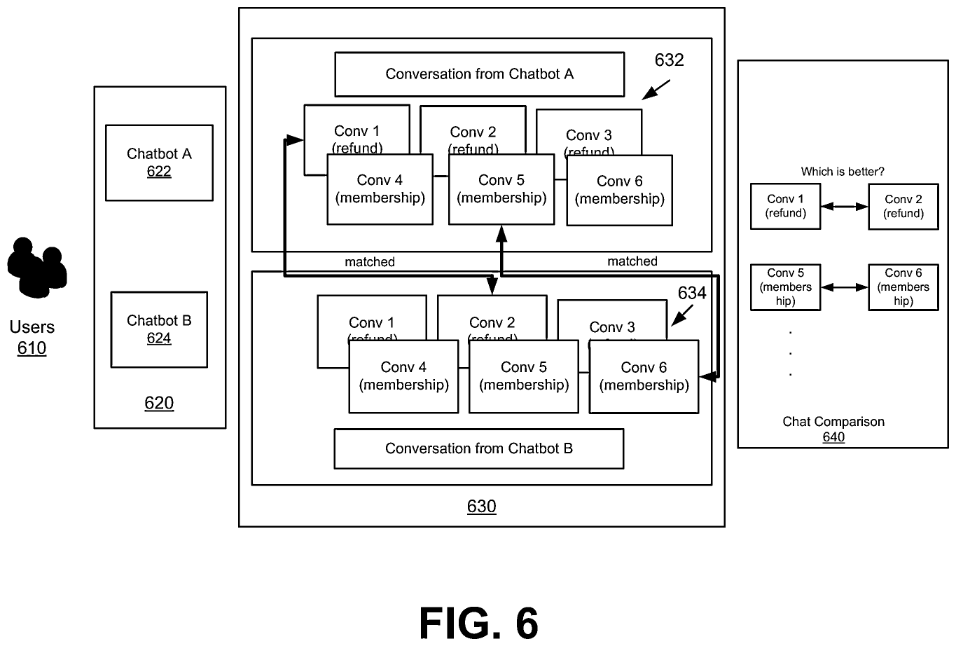

The chatbot evaluation module 227 matches conversations from the first chatbot application to similar conversations from the second chatbot application to generate one or more pairs of matching conversations. The chatbot evaluation module 227 may match conversations based on a user issue of the matched conversations. For example, conversation 1 and conversation 2 may both be conversations requesting a refund. As another example, conversations 5 and 6 may both be conversations about membership questions. For each matched pair of conversations, the chatbot evaluation module 227 generates one or more evaluations that compare the chatbot applications on handling the user issue based on the comparison of the matched conversations. For example, the chatbot evaluation module 227 may evaluate each chatbot application on its handling of the issue of possible refunds or membership questions. This process is described in further detail in conjunction with FIG. 6.

In one or more embodiments, the chatbot evaluation module 227 receives a transcript of a chatbot application with a user. The conversation includes at least a sequence of messages from the user and a respective response to each user message from the chatbot application. For each of the sequence of user messages, the chatbot evaluation module 227 simulates responses using a second chatbot application different from the first chatbot application. The chatbot evaluation module 227 simulates a response to the user message by providing the user message to the second chatbot application. For each response, the chatbot evaluation module 227 evaluates the response from the second chatbot application as compared to the corresponding response from the first chatbot application in the original transcript. The chatbot evaluation module 227 determines a prior context similarity between previously simulated responses and corresponding responses in the original transcript. The chatbot evaluation module 227 generates a confidence score for the evaluation of the second chatbot application based on the prior context similarity. The confidence score is higher when the prior context similarity is higher.

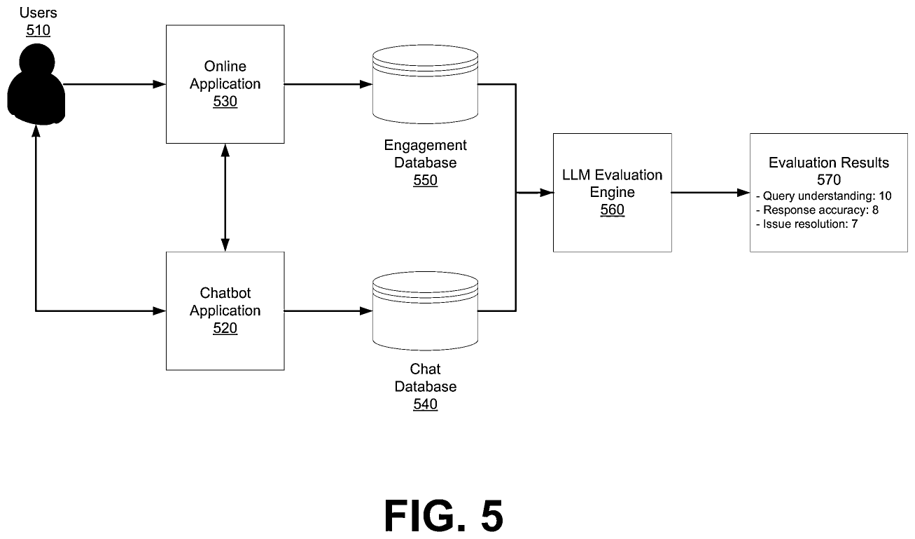

FIG. 5 is a flowchart for a method of evaluating chatbots using post conversation user engagement data, in accordance with some embodiments. Alternative embodiments may include more, fewer, or different steps from those illustrated in FIG. 5, and the steps may be performed in a different order from that illustrated in FIG. 5. These steps may be performed by an online concierge system (e.g., online concierge system 140). Additionally, each of these steps may be performed automatically by the online concierge system without human intervention.

One or more users 510 engage with the chatbot application 520 and an application 530 of the online system 140. The chat database 540 stores the transcripts of conversations with the chatbot application 520. The engagement database 550 stores engagement data associated with the application 530. The chatbot evaluation module 227 accesses both the chat database 540 and the engagement database 550 and provides the data to the evaluation engine 560, which may be powered by an LLM.

Through the evaluation engine 560, conversations between the chatbot and a user 510 are assessed based on specific criteria such as understanding user queries, accuracy of responses, and issue resolution rates. In one or more embodiments, issue resolution may be identified by checking the user's order history. Each conversation receives a score across these key dimensions, accompanied by an explanation for the 'ed score.

As an example, a transcript of a conversation with a user 510 may include the following:
AI Chatbot: Hello! I'm your virtual assistant. What can I help you with today?
User: Need to cancel order.
AI Chatbot: Sure, you can cancel an order for a full refund without any additional fees before a shopper begins shopping. Here's how you can do it:
On the website: 1. At the top left, click the 3 horizontal lines. 2. Click ‘Your Orders’. 3. Click ‘View order detail’ on the relevant order. 4. Click ‘Manage Order’. 5. Click ‘Cancel my order’. On the app: 1. Tap the 3 horizontal lines in the upper left-hand corner. 2. Tap ‘Your orders’. 3.
Select the order you want to cancel. 4. On the order page, scroll down to ‘Manage order’. 5. Tap ‘Cancel this order’. Please note, if you cancel an order during the shopping or delivery process, you may be charged a cancellation fee. To cancel after shopping has begun, reach out to Customer Experience by selecting ‘Contact Us’ at the bottom of any article in the Help Center.

The chatbot evaluation module 227 may prepare a prompt for the evaluation engine 560 which includes this transcript as well as records from the engagement database 550 regarding whether the order was actually cancelled following this conversation.

The output from the evaluation engine 560 may include a table like the below:

### Evaluation Result

| | Score | |
|---|---|---|
| Criteria | (1~10) | Rationale |
| User query | 10 | The assistant understood the |
| understanding | | user's request to cancel an |
| | | order and provided the correct |
| | | steps to do so. |
| Response | 10 | The assistant provided |
| accuracy | | accurate and relevant |
| | | information on how to cancel |
| | | an order. |
| Chat efficiency | 10 | The assistant provided the |
| | | necessary information to |
| | | cancel an order in a single |
| | | response, making the |
| | | conversation efficient. |
| Issue resolution | 10 | The order was canceled as |
| | | requested by the user. |

The evaluation criteria can vary based on the chatbot's purpose. For example, a customer support chatbot may be measured by its issue resolution rate, whereas a meal planning bot might be evaluated by its item-add-to-cart rate, among other factors. The engine's connection to the engagement database (subject to user consent) enables it to access pertinent information, ensuring real-time and objective evaluations. In some embodiments, the system catalogs which chatbot applications receive higher evaluations associated with resolving issues, and the system may determine which chatbot to be implemented for each user issue based on these evaluations.

FIG. 6 is a flowchart for a method of matching chatbot conversations for comparison, in accordance with some embodiments. Alternative embodiments may include more, fewer, or different steps from those illustrated in FIG. 6, and the steps may be performed in a different order from that illustrated in FIG. 6. These steps may be performed by an online concierge system (e.g., online concierge system 140). Additionally, each of these steps may be performed automatically by the online concierge system without human intervention.

Users 610 interact with chatbot applications 620, either chatbot application A 622 or chatbot application B 624, creating transcripts of conversations 630. The chatbot evaluation module 227, using a machine learning model, pairs conversations based on their semantic similarity such that a conversation 632 with chatbot A 622 is paired with a similar conversation 634 with chatbot B 624. Specifically, the chatbot evaluation module 227 generates embeddings using LLM for each chat, then matches conversations between two chatbot versions based on these embeddings' likeness. The method described herein allows an entity to compare performance of different generative AI applications when the generated data is, for example, unstructured and difficult to compare quantitatively with other instances of the data.

After pairing the conversations 630, the chatbot evaluation module 227 conducts the comparisons 640 for each paired set, utilizing the conversation-level evaluation method previously outlined in conjunction with FIG. 5. The cumulative difference in performance between the two chatbot applications can then be determined by aggregating the results from these paired evaluations.

Chatbot B 624 is an enhanced version of Chatbot A 622, and both address various customer support topics or issues. Through embedding, Conversation 1 from Chatbot A aligns with Conversation 2 from Chatbot B, given their notable resemblance on refund inquiries. Similarly, Conversation 5 from Chatbot A is paired with Conversation 6 from Chatbot B, reflecting their emphasis on membership discussions. The pairing mechanism enables the system to amass a vast dataset across varied topics, thus enriching the breadth and resilience of the evaluation.

In some embodiments, when the chatbot evaluation module 227 lacks a sufficient set of similar conversations to compare full conversations between different chatbot versions, the chatbot evaluation module 227 can instead simulate finer-grained comparisons.

For example, for a conversation with many back-and-forth messages between a user and the chatbot application (labelled H1, C1, H2, C2, etc. to HN, CN, the final message between the two). Wherever a conversation's good or bad outcome can be attributed to a specific message, an alternate chatbot model can be tested on whether the outputs would have had a different outcome given an identical preceding conversation as context.

For example, suppose CN is the final decision to refuse a refund. The chatbot evaluation module 227 can prompt an alternate chatbot application, C_alt, with the prior conversation context H1, C1, . . . . HN, and then compute C_altN. If C_alt decides to issue a refund instead then it is generally more inclined to produce this different resolution (with the attending advantages of customer satisfaction and disadvantages in extra cost).

The advantages of this solution are that the online system 140 can get a very precise comparison between two chatbots even when the number of conversations in the database is small. In the case of very short conversations, a single question from a human, there is likely no disadvantage. In the case of long conversations, there is path-dependence in the conversation since if C_alt had been the chatbot for the whole conversation it likely would have diverged from the actual context given, but both small changes and dynamic policies of switching between different chatbots can still be usefully tested.

If the alternative chatbot C_alt's earlier responses are very similar to C's, the chatbot evaluation module 227 can place higher confidence in the evaluation of its later responses. If the responses diverge, the chatbot evaluation module 227 knows that there should be lower confidence in the evaluations since the prior path of the conversation will be different. This way, the chatbot evaluation module 227 can validate that a newer alternate chatbot produces similar actions to a baseline chatbot throughout every step of the conversation. These simulations can also serve as training data for reinforcement learning of a dynamic chatbot switching policy. In one or more embodiments, the set of LLM services described in conjunction with

FIGS. 2 and 3 may each power the different chatbot applications, and the LLM gateway module 225 may obtain evaluations of the chatbot applications to determine which LLM service to select for a given user when the user would like to interact with a chatbot. For example, chatbot application A 622 may be powered by LLM service A in FIG. 3 and chatbot application B 624 may be powered by LLM service B in FIG. 3. The LLM gateway module 225 may select the LLM service with a better evaluation with respect to a set of criteria. This allows the LLM gateway module 225 to select an LLM service based on the higher-granularity evaluations that are conducted on an issue-by-issue and conversation-by-conversation basis.

### Additional Considerations

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A computer-implemented method comprising:
receiving, from a user of a client device, a query for an application with access to one or more of a set of LLM services;
obtaining contextual information as a set of features, the set of features related to the query or the user of the client device;
applying at least one machine-learning contextual bandit model to the set of features to generate a set of predicted scores, wherein each predicted score in the set of predicted scores indicates how effective a response from a respective LLM service in the set of LLM services is with respect to a desired outcome;
selecting an LLM service in the set of LLM services based at least on the set of predicted scores from the contextual bandit model;
generating a prompt for input to the selected LLM service, wherein the prompt for the selected LLM service is generated based on a prompt template in a prompt library database associated with the selected LLM service; and
receiving, from the selected LLM service, a response generated by executing the selected LLM service on the prompt.

2. The computer-implemented method of claim 1, further comprising:
obtaining values for the set of LLM services for one or more performance metrics, wherein the performance metrics for a respective LLM service comprises at least one or a combination of an expected quality of a response generated by the respective LLM service, a latency of the respective LLM service for generating a response, and a cost of the respective LLM service for generating a response, and wherein the LLM service is selected further based on the values for the one or more performance metrics.

3. The computer-implemented method of claim 2, further comprising:
generating, a set of prompts for input to the set of LLM services;
receiving, from the set of LLM services, a set of responses by executing the set of prompts by the set of LLM services; and
obtaining the values for the one or more performance metrics from the set of responses.

4. The computer-implemented method of claim 1, wherein the set of features includes at least one or a combination of information obtained from the query, one or more characteristics of the user, an order status of the user with an online system, and an issue category assigned to the query.

5. The computer-implemented method of claim 4, wherein obtaining the contextual information further comprises:
applying a machine-learning embedding model to a text or image obtained from the query to generate a query embedding mapping the query in a latent space, wherein the set of features includes the query embedding.

6. The computer-implemented method of claim 1, wherein when the query is a user support query, each predicted score from the contextual bandit model indicates how effective the response from the respective LLM service is for achieving the desired outcome of user satisfaction after the user support query has been addressed.

7. The computer-implemented method of claim 1, wherein when the query includes an opportunity to respond with a message for a sponsored item, each predicted score indicates how effective the response from the respective LLM service is for the desired outcome of the user adding the sponsored item to a user's order.

8. The computer-implemented method of claim 1, wherein the contextual bandit model is trained by a process of:
obtaining a training dataset including one or more training examples, a training example obtained from logs for a previously submitted query processed by the LLM service or another LLM service, the training example including a training set of features and a known outcome for the previously submitted query; and
training one or more parameters of the contextual bandit model on the one or more training examples of the training dataset.

9. The computer-implemented method of claim 1, further comprising:
obtaining an indication that the user performed the desired outcome after receiving the response;
generating a training example including the set of features and a label indicating the desired outcome was performed; and
training one or more parameters of the contextual bandit model on the training example.

10. The computer-implemented method of claim 1, further comprising:
prompting the selected LLM service to process subsequent queries from the user of the client device.

11. A non-transitory computer-readable storage medium storing computer instructions, wherein the computer instructions, when executed by one or more processors, cause the one or more processors to perform operations comprising:
receiving, from a user of a client device, a query for an application with access to one or more of a set of LLM services;
obtaining contextual information as a set of features, the set of features related to the query or the user of the client device;
applying at least one machine-learning contextual bandit model to the set of features to generate a set of predicted scores, wherein each predicted score in the set of predicted scores indicates how effective a response from a respective LLM service in the set of LLM services is with respect to a desired outcome;
selecting an LLM service in the set of LLM services based at least on the set of predicted scores from the contextual bandit model;
generating a prompt for input to the selected LLM service, wherein the prompt for the selected LLM service is generated based on a prompt template in a prompt library database associated with the selected LLM service;
receiving, from the selected LLM service, a response generated by executing the selected LLM service on the prompt; and
prompting the selected LLM service to process subsequent queries from the user of the client device.

12. The non-transitory computer-readable storage medium of claim 11, the operations further comprising:
obtaining values for the set of LLM services for one or more performance metrics, wherein the performance metrics for a respective LLM service comprises at least one or a combination of an expected quality of a response generated by the respective LLM service, a latency of the respective LLM service for generating a response, and a cost of the respective LLM service for generating a response, and wherein the LLM service is selected further based on the values for the one or more performance metrics.

13. The non-transitory computer-readable storage medium of claim 12, the operations further comprising:
generating, a set of prompts for input to the set of LLM services;
receiving, from the set of LLM services, a set of responses by executing the set of prompts by the set of LLM services; and
obtaining the values for the one or more performance metrics from the set of responses.

14. The non-transitory computer-readable storage medium of claim 11, wherein the set of features includes at least one or a combination of information obtained from the query, one or more characteristics of the user, an order status of the user with an online system, and an issue category assigned to the query.

15. The non-transitory computer-readable storage medium of claim 14, wherein obtaining the contextual information further comprises:
applying a machine-learning embedding model to a text or image obtained from the query to generate a query embedding mapping the query in a latent space, wherein the set of features includes the query embedding.

16. The non-transitory computer-readable storage medium of claim 11, wherein when the query is a user support query, each predicted score from the contextual bandit model indicates how effective the response from the respective LLM service is for achieving the desired outcome of user satisfaction after the user support query has been addressed.

17. The non-transitory computer-readable storage medium of claim 11, wherein when the query includes an opportunity to respond with a message for a sponsored item, each predicted score indicates how effective the response from the respective LLM service is for the desired outcome of the user adding the sponsored item to a user's order.

18. The non-transitory computer-readable storage medium of claim 11, wherein the contextual bandit model is trained by the process of:
obtaining a training dataset including one or more training examples, a training example obtained from logs for a previously submitted query processed by the LLM service or another LLM service, the training example including a training set of features and a known outcome for the previously submitted query; and
training one or more parameters of the contextual bandit model on the one or more training examples of the training dataset.

19. The non-transitory computer-readable medium of claim of claim 11, the operations further comprising:
obtaining an indication that the user performed the desired outcome after receiving the response;
generating a training example including the set of features and a label indicating the desired outcome was performed; and
training one or more parameters of the contextual bandit model on the training example.

20. A computer system, comprising:
one or more processors; and
a non-transitory computer-readable storage medium storing computer instructions, wherein the computer instructions, when executed by the one or more processors, cause the one or more processors to perform operations comprising:
receiving, from a user of a client device, a query for an application with access to one or more of a set of LLM services;
obtaining contextual information as a set of features, the set of features related to the query or the user of the client device;
applying at least one machine-learning contextual bandit model to the set of features to generate a set of predicted scores, wherein each predicted score in the set of predicted scores indicates how effective a response from a respective LLM service in the set of LLM services is with respect to a desired outcome;
selecting an LLM service in the set of LLM services based at least on the set of predicted scores from the contextual bandit model;
generating a prompt for input to the selected LLM service, wherein the prompt for the selected LLM service is generated based on a prompt template in a prompt library database associated with the selected LLM service;
receiving, from the selected LLM service, a response generated by executing the selected LLM service on the prompt; and
prompting the selected LLM service to process subsequent queries from the user of the client device.
